(19) United States
(12) Patent Application Publication
(10) Pub. No.: US 2025/0011585 A1
(43) Pub. Date: Jan. 9, 2025

(54) ELECTRICALLY CONDUCTIVE HYALURONIC ACID VIA THIOPHENE CONJUGATION

(71) Applicant: Board of Regents, The University of Texas System, Austin, TX (US)

(72) Inventors: Sylvia Lucia Natividad-Diaz, El Paso, TX (US); Britanny L. Stark, El Paso, TX (US)

(21) Appl. No.: 18/733,235

(22) Filed: Jun. 4, 2024

Related U.S. Application Data
(60) Provisional application No. 63/512,192, filed on Jul. 6, 2023.
(60) Provisional application No. 63/655,448, filed on Jun. 3, 2024.

(51) Int. Cl. C08L 5/08; C08B 37/08

(52) U.S. Cl. CPC C08L 5/08; C08B 37/0072; C08L 2203/02; C08L 2203/20

(57) ABSTRACT

An engineered material includes methacrylated hyaluronic acid conjugated with 3-thiophene acetic acid or with poly(3-thiophene) acetic acid. Preparation can include Fischer esterification of methacrylated hyaluronic acid with 3-thiophene acetic acid or with poly(3-thiophene) acetic acid in the presence of an acid activator to produce methacrylated hyaluronic acid conjugated with 3-thiopheneacetic acid or with poly(3-thiophene) acetic acid. Precursor preparation can include doping the 3-thiophene acetic acid or poly(3-thiophene) acetic acid with iodine for example to influence conductivity.

### CROSS-REFERENCE TO RELATED APPLICATIONS

Referring to the application data sheet filed herewith, this application claims a benefit of priority under 35 U.S.C. 119 (e) from co-pending provisional U.S. Ser. No. 63/512,192, filed Jul. 6, 2023, (attorney docket number UTEP2023-008-PROV) and U.S. Ser. No. 63/655,448 filed Jun. 3, 2024, (attorney docket number UTEP2023-008-PROV-2), the entire contents of both of which are hereby expressly incorporated herein by reference for all purposes.

### STATEMENT AS TO RIGHTS TO INVENTIONS MADE UNDER FEDERALLY-SPONSORED RESEARCH OR DEVELOPMENT

This invention was made with government support under 1SC2GM144164-01 awarded by NIH/NIGMS. The government has certain rights in the invention.

### BACKGROUND

Hyaluronic Acid is the most abundant glycosaminoglycan in the body and the main component for many tissues. It contributes to tissue hydrodynamics, movement and proliferation of the cells. Additionally, hyaluronic acid is chemically versatile, which allows it to be modified easily while remaining biocompatible.

Referring to FIG. 1, methacrylated hyaluronic acid (Me-HA) adds a UV cross linkable component to hyaluronic acid, making it possible to 3D print hydrogels for tissue engineering applications. A problem with this technology has been how to make and use such a 3D printable, UV curable hydrogel conductive for electronic or even electrical purposes.

There is a need for electron-hoe conductive 3D printable hydrogels for tissue engineering. Previous approaches to producing conductive methacylated hyaluronic acid have not been entirely successful and research continues for alternative methacylated hyaluronic acid based materials that are conductive. Therefore, what is required are better approaches to making methacrylated hyaluronic acid (Me-HA) into a conductive material.

Meanwhile, in other fields, thiophene is known as a colorless heterocyclic compound. In medicine, thiophene is known as an anti-inflammatory, an anti-psychotic, and an anti-arrhythmic. In material science, thiophene is known for its use in compositions that are inhibitors of corrosion in metals and for use in components for light-emitting diodes.

Referring to FIG. 2, when treated with an oxidizing agent, thiophene electrons are delocalized via a process called doping. Doping intentionally introduces impurities into a compound to change its electrical properties. The delocalized electrons move along the polymer backbone forming a charged unit called a bipolaron.

Heretofore, the requirement of making methacrylated hyaluronic acid (Me-HA) into a conductive material referred to above has not been fully met. In view of the foregoing, there is a need in the art for a solution that solves this problem.

### SUMMARY

There is a need for the following embodiments of the present disclosure. Of course, the present disclosure is not limited to these embodiments.

In this project, a novel conjugate between Me-HA and 3-thiopheneacetic acid (3TAA) has been developed to make an electrically conductive hyaluronic acid polymer and solid hydrogel. The 3TAA contains thiophene, a chemical compound that can be doped to introduce electrical conductivity. Overall, conjugating 3TAA to Me-HA will create an electrically conductive hydrogel for cardiac and neural tissue engineering applications. This electrically conductive hyaluronic acid hydrogel also has applications in the electronic devices industry. Since the electrically conductive hyaluronic acid polymer can be crosslinked with UV and LAP, this material can also be printed into a solid customized shape with the fabrication technique called 3D stereolithography (SLA) printing.

According to another embodiment of the present disclosure, a composition of matter comprises: methacrylated hyaluronic acid conjugated with 3-thiophene acetic acid or with poly(3-thiophene) acetic acid.

According to another embodiment of the present disclosure, a method comprises Fischer esterification of methacrylated hyaluronic acid with 3-thiophene acetic acid in the presence of an acid activator to produce methacrylated hyaluronic acid conjugated with 3-thiopheneacetic acid.

According to another embodiment of the present disclosure, a method comprises Fischer esterification of methacrylated hyaluronic acid with poly(3-thiophene) acetic acid in the presence of an acid activator to a produce methacrylated hyaluronic acid conjugated with poly(3-thiophene) acetic acid.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements).

FIG. 1 is a chemical structural representation of methacrylated hyaluronic acid, appropriately labeled “PRIOR ART.”

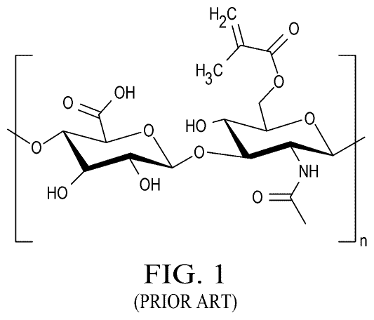

FIG. 2 is a chemical structural representation of thiophene, appropriately labeled “PRIOR ART.”

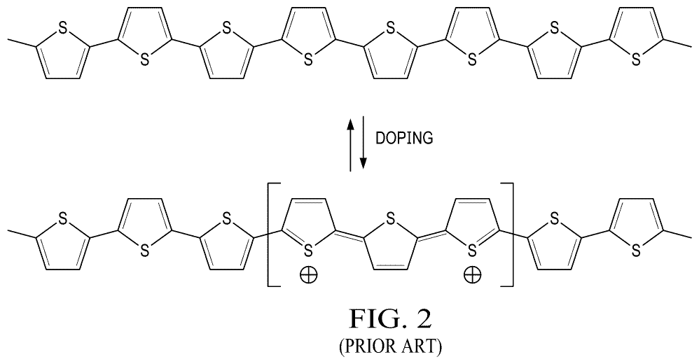

FIG. 3 is a chemical reaction representation of an example of a reaction of methacrylated hyaluronic acid and thiophene using carbonyldiimidazole (CDI).

FIG. 4 is a chemical reaction representation of an example of a reaction of methacrylated hyaluronic acid and thiophene using sulfuric acid.

FIG. 5 is a presentation of preliminary results including doping of 3TAA with iodine to introduce electrical conductivity properties.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well-known materials, techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Embodiments of this disclosure include an electrically conductive hyaluronic acid polymer that can be cross-linked with UV light and lithium phenyl-2,4,6-trimethylbenzoylphosphinate (LAP) to form a solid hydrogel. Embodiments of this disclosure include methacrylate hyaluronic acid conjugation with 3-thiopheneacetic acid.

Embodiments of this disclosure can achieve the conjugation with various chemistries. For example, the reaction chemistry can be driven by CDI (carbonyldiimidazole). As another example, the reaction chemistry can be driven by H₂SO₄ (sulfuric acid). As another example, the reaction chemistry can be driven by 1-Ethyl-3-(3-dimethylaminopropyl) carbodiimide (EDC). As another example, the reaction chemistry can be driven by hydroxybenzotriazole (HOBT)

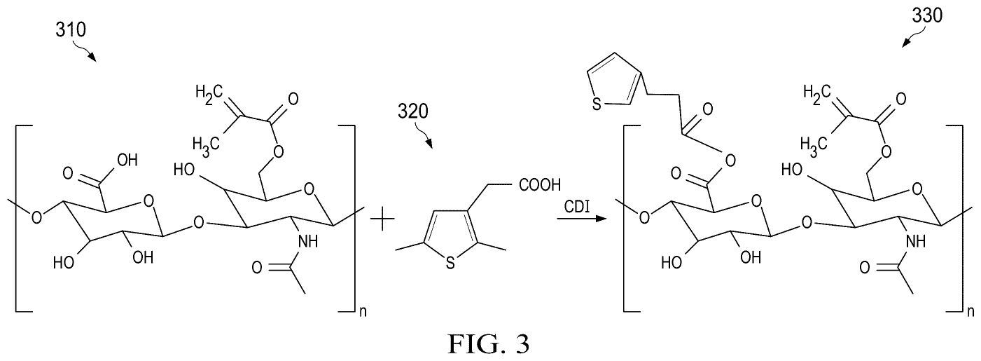

Referring to FIG. 3, methacrylated hyaluronic acid 310 is reacted with 3-thiopheneacetic acid 320 in the presence of CDI (carbonyldiimidazole) as an acid activator to produce methacrylated hyaluronic acid conjugated with 3-thiophene acetic acid 330.

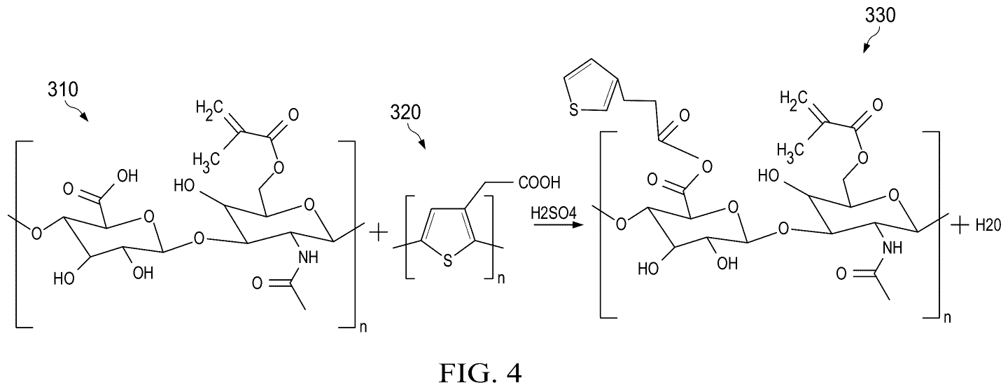

Referring to FIG. 4, methacrylated hyaluronic acid 310 is reacted with 3-thiopheneacetic acid 320 in the presence of H₂SO₄ (sulfuric acid) as an acid activator to produce methacrylated hyaluronic acid conjugated with 3-thiophene acetic acid 330.

A non-mutually exclusive alternative to conjugating with 3-thiopheneacetic acid (3TAA) is an initial polymerization of a source of 3TAA, and subsequent doping with Ferric Chloride or sulfuric acid, to make poly(3-thiophene) acetic acid. Embodiments of this disclosure can achieve this P3TAA conjugation with various chemistries. For example, this reaction chemistry can be driven by CDI (carbonyldiimidazole). As another example, this reaction chemistry can be driven by H₂SO₄ (sulfuric acid). As another example, this reaction chemistry can be driven by 1-Ethyl-3-(3-dimethylaminopropyl) carbodiimide (EDC). As another example, this reaction chemistry can be driven by hydroxybenzotriazole (HOBT).

### EXAMPLES

Specific exemplary embodiments will now be further described by the following, nonlimiting examples which will serve to illustrate in some detail various features. The following examples are included to facilitate an understanding of ways in which embodiments of the present disclosure may be practiced. However, it should be appreciated that many changes can be made in the exemplary embodiments which are disclosed while still obtaining like or similar result without departing from the scope of embodiments of the present disclosure. Accordingly, the examples should not be construed as limiting the scope of the present disclosure.

### List of Reagents:

Methacrylated Hyaluronic Acid
   Sigma-Aldrich, 100 mg-100-150 kDa, SKU #CC327-2
3-thiopheneacetic Acid
   Sigma-Aldrich, 10 g, 142.18 Da, SKU #220639-10G
Pure iodine
   Sigma-Aldrich, 5 g, SKU #207772-5G
Carbonyldiimidazole (CDI)
   Sigma-Aldrich, 5 g, SKU #115533-5G

### Generic Protocol:

3-thiopheneacetic acid doped with iodine
   Dissolve 3-thiopheneacetic acid in 10 mLs DI water with 2 mg of iodine Stir for 24 hours at 350 rpms.

### Example 1

In this example, methacrylate hyaluronic acid is conjugated with 3-thiopheneacetic acid in the presence of CDI (carbonyldiimidazole). Once 3TAA is doped, add solution into 100 mg of Methacrylate Hyaluronic Acid, and 1 mg of carbonyldiimidazole (CDI) as a carboxylic acid activator. Then, stir for 24 hours at 350 rpms. Then filter using a membrane of 8 kDa for 24 hours against DI water.

In an alternative to this example, methacrylate hyaluronic acid is conjugated with 3-thiopheneacetic acid in the presence of H₂SO₄ (sulfuric acid). In an alternative to this example, methacrylate hyaluronic acid is conjugated with 3-thiopheneacetic acid in the presence of 1-Ethyl-3-(3-dimethylaminopropyl) carbodiimide (EDC). In an alternative to this example, methacrylate hyaluronic acid is conjugated with 3-thiopheneacetic acid in the presence of hydroxybenzotriazole (HOBT).

### Example 2

A non-mutually exclusive alternative to conjugating with 3-thiopheneacetic acid (3TAA) is an initial polymerization of a source of 3TAA, and subsequent doping with Ferric Chloride or sulfuric acid, to make poly(3-thiophene) acetic acid. Then add the P3TAA solution into 100 mg of Me-HA, and Img of CDI as a catalyst. Then, stir for 24 hours at 350 rpms. Finally, filter using a membrane of 8 kDa for 24 hours against DI water.

In an alternative to this example, methacrylate hyaluronic acid is conjugated with P3TAA in the presence of H₂SO₄ (sulfuric acid). In an alternative to this example, methacrylate hyaluronic acid is conjugated with P3TAA in the presence of 1-Ethyl-3-(3-dimethylaminopropyl) carbodiimide (EDC). In an alternative to this example, methacrylate hyaluronic acid is conjugated with P3TAA in the presence of hydroxybenzotriazole (HOBT).

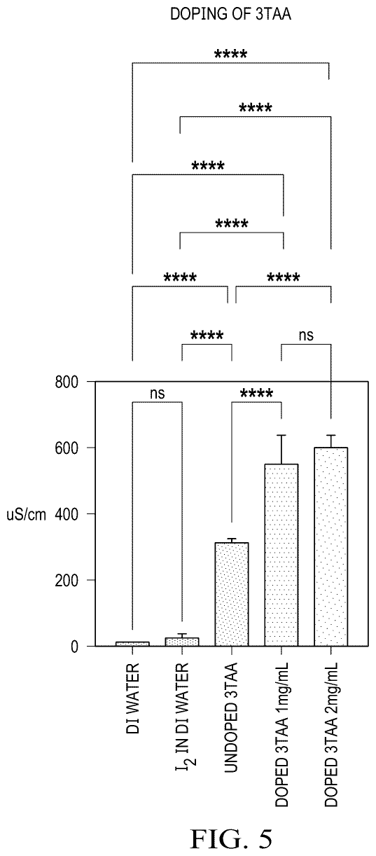

Referring to FIG. 5, a statistically significant difference in conductivity uS/cm was found between doped 3TAA and undoped 3TAA, DI water, and iodine in DI water. This indicates that 3TAA can be electrically conductive, which when conjugated into Me-HA will in turn, make the hydrogel conductive. Conductivity measurements taken with a Dynamic Light Scattering system (DLS)

A practical application of an embodiment of the present disclosure that has value within the technological arts is conjugating 3TAA to Me-HA to create an electrically conductive hydrogel for cardiac and neural tissue engineering applications. Further, embodiments of the present disclosure are useful in electronic devices (such as are used for the purpose of wearables for example hearing aids or eyeglasses), or in conjunction with an implantable (such as are used for the purpose of prosthesis or the like. There are virtually innumerable uses for embodiments of the present disclosure, all of which need not be detailed here.

Embodiments of the present disclosure can be cost effective and advantageous for at least the following reasons.

Embodiments conjugating 3TAA to Me-HA create an electrically conductive hydrogel for cardiac and neural tissue engineering applications. This electrically conductive hyaluronic acid hydrogel also has applications in the electronic devices industry, especially implantable devices. Since the electrically conductive hyaluronic acid polymer can be crosslinked with UV and LAP, embodiments can be printed into a solid customized shape, such as with the fabrication technique called 3D stereolithography (SLA) printing. Embodiments provide stable, biocompatible conductive hydrogel products. Embodiments of the present disclosure improve quality and/or reduce costs compared to previous approaches.

Key terms and abbreviations include: Hyaluronic Acid (HA), Methacrylated hyaluronic acid (Me=HA), 3-thiophene acetic acid (3TAA), poly(3-thiophene) acetic acid (3TAA) Carbonyldiimidazole (CDI), Sulfuric Acid (H₂SO₄), 1-Ethyl-3-(3-dimethylaminopropyl) carbodiimide (EDC), hydroxybenzotriazole (HOBT), Lithium phenyl-2,4,6-trimethylbenzoylphosphinate (LAP), stereolithography (SLA), and Ultraviolet light (UV).

The term compound is intended to mean a substance formed when two or more chemical elements are chemically bonded together, the elements present in ratios with a limited range of variation and characteristic crystal structure. The term phase is intended to mean a limited range of compositions of a mixture of the elements (in a thermochemical system) throughout which the chemical potential of the mixture varies with composition, and which either changes discontinuously or remains constant outside of that range. The phrase cation content is intended to mean the percentage or relative amount of a given cation of interest (relative to total cations) in a given volume or mass of interest. The term absorber is intended to mean the photon absorbing portion of a photovoltaic. The term buffer is intended to mean the junction forming region of a photovoltaic. The term emitter is intended to mean the negative contact of an illuminated photovoltaic without current flow. The term amorphous transparent conductive layer is intended to mean a non-crystalline, substantially photon transparent, electronically conducting portion of a photovoltaic. The term back contact is intended to mean the contact of a photovoltaic on the side opposite the incident illumination. The term photovoltaic is intended to mean an article of manufacture for the generation of a voltage when radiant energy falls on the boundary between dissimilar substances (as two different semiconductors).

The term uniformly is intended to mean unvarying or deviating very little from a given and/or expected value (e.g, within 10% of). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub) method, (sub) process and/or (sub) routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be formed in the disclosed shapes, or combined in the disclosed configurations, but could be provided in any and all shapes, and/or combined in any and all configurations. The individual components need not be fabricated from the disclosed materials but could be fabricated from any and all suitable materials. Homologous replacements may be substituted for the substances described herein. Agents which are both chemically and physiologically related may be substituted for the agents described herein where the same or similar results would be achieved.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of this disclosure are delineated by the appended independent claims and their equivalents. Specific embodiments of this disclosure are differentiated by the appended dependent claims and their equivalents.

What is claimed is:

1. A composition of matter, comprising methacrylated hyaluronic acid conjugated with 3-thiophene acetic acid.

2. The composition of claim 1, wherein the methacrylated hyaluronic acid conjugated with poly(3-thiophene) acetic acid is prepared by Fischer esterification in the presence of an acid activator selected from the group consisting of carbonyldiimidazole (CDI), sulfuric acid, 1-Ethyl-3-(3-dimethylaminopropyl) carbodiimide (EDC), and hydroxybenzotriazole (HOBT).

3. The composition of claim 1, for use as a cardiac tissue.

4. The composition of claim 1, for use as neural tissue.

5. A hydrogel compound, comprising the composition of claim 1.

6. An electronic device, comprising the composition of claim 1.

7. A composition of matter, comprising methacrylated hyaluronic acid conjugated with poly(3-thiophene) acetic acid.

8. The composition of claim 7, wherein the methacrylated hyaluronic acid conjugated with poly(3-thiophene) acetic acid is prepared by Fischer esterification in the presence of an acid activator selected from the group consisting of carbonyldiimidazole (CDI), sulfuric acid, 1-Ethyl-3-(3-dimethylaminopropyl) carbodiimide (EDC), and hydroxybenzotriazole (HOBT).

9. The composition of claim 7, for use as a cardiac tissue.

10. The composition of claim 7, for use as neural tissue.

11. A hydrogel compound, comprising the composition of claim 7.

12. An electronic device, comprising the composition of claim 7.

13. A method, comprising Fischer esterification comprising reacting methacrylated hyaluronic acid with 3-thiophene acetic acid in the presence of an acid activator to produce methacrylated hyaluronic acid conjugated with 3-thiopheneacetic acid.

14. The method of claim 13, wherein the acid activator comprises carbonyldiimidazole (CDI).

15. The method of claim 13, wherein the acid activator comprises sulfuric acid.

16. The method of claim 13, wherein the acid activator comprises 1-Ethyl-3-(3-dimethylaminopropyl) carbodiimide (EDC).

17. The method of claim 13, wherein the acid activator comprises hydroxybenzotriazole (HOBT).

18. The method of claim 13, further comprising, before reacting, doping the 3-thiopheneacetic acid with iodine.

19. A method, comprising Fischer esterification comprising reacting methacrylated hyaluronic acid with poly(3-thiophene) acetic acid in the presence of an acid activator to a produce methacrylated hyaluronic acid conjugated with poly(3-thiophene) acetic acid.

20. The method of claim 19, wherein the acid activator comprises carbonyldiimidazole (CDI).

21. The method of claim 19, wherein the acid activator comprises sulfuric acid.

22. The method of claim 19, wherein the acid activator comprises 1-Ethyl-3-(3-dimethylaminopropyl) carbodiimide (EDC).

23. The method of claim 19, wherein the acid activator comprises hydroxybenzotriazole (HOBT).

24. The method of claim 19, further comprising, before reacting, doping the poly(3-thiophene) acetic acid with iodine.
